(19) United States
(12) Patent Application Publication
(10) Pub. No.: US 2007/0009423 A1
(43) Pub. Date: Jan. 11, 2007

(54) Apparatus and Methods For Producing Calcium Chloride, and Compositions and Products Made Therefrom

(75) Inventors: Russell F Handy, Spring, TX (US); Rick A Billings, The Woodlands, TX (US); Stephen R Fox, The Woodlands, TX (US)

Correspondence Address: Jimmy Mark Gilbreth, P. O. Box 2428, Bellaire, TX, 77402-2428, US

(73) Assignee: ECO PRODUCTS, L.P., The Woodlands (US)

(21) Appl. No.: 11/160,685

(22) Filed: Jul. 5, 2005

(51) Int. Cl. C01F 11/20

(52) U.S. Cl. 423/497

(57) ABSTRACT

A method of producing calcium chloride including first forming a slurry of solid calcium oxide in an aqueous solution of calcium chloride, and then contacting the slurry with hydrochloric acid to convert at least a portion of the calcium oxide into calcium chloride.

### BACKGROUND OF THE INVENTION

1. Field of the Invention

The present invention is directed to apparatus and methods for producing calcium halides, and to compositions and products made therefrom. In another aspect the present invention is directed to apparatus and methods for converting calcium oxide and/or calcium hydroxide to calcium halides, and to compositions and products made therefrom. In still another aspect, the present invention is directed to apparatus and methods for producing calcium chlorides, and to compositions and products made therefrom.

2. Description of the Related Art

Calcium chloride (CaCl₂) is an extremely versatile chemical compound and is used in a wide range of industrial, commercial, food processing, and agricultural applications. For many years calcium chloride was produced as a by-product in the Solvay process used for producing soda ash. In this process recovery of ammonia (NH₃) from the process liquors containing ammonium chloride is achieved by adding milk of lime [Ca(OH)₂] to the liquors which also results in production of calcium chloride. The calcium chloride liquors are then clarified, concentrated by evaporation, crystallized and melted to produce flake calcium chloride. This method of production of calcium chloride was lost with the demise of soda ash manufacturing by the Solvay Process in the United States.

A large percentage of the calcium chloride production has been replaced by the reaction of hydrochloric acid (HCl) with calcium carbonate (CaCO₃) to produce a calcium chloride solution.

U.S. Pat. No. 4,299,809, issued Nov. 10, 1981, to Teyssier et al., is directed to a process for the production of calcium chloride by the reaction of hydrochloric acid with calcium carbonate in the upper sealed portion of a reactor bordered on one side by a filtration sieve. The process comprises reacting the hydrochloric acid with the calcium carbonate to produce carbon dioxide and a calcium chloride solution, and pressuring the solution of calcium chloride by means of the carbon dioxide across the sieve and towards an outlet of the reactor.

U.S. Pat. No. 4,348,371, issued, Sep. 7, 1982, to Saeman et al., and U.S. Pat. No. 4,348,372, issued, Sep. 7, 1982, to Duncan et al. are directed to processes for recovering calcium salts from calcium hypochlorite process effluents. In producing hemibasic and dibasic hypochlorite, a slurry of lime is chlorinated to produce hypochlorite crystals which are separated from a filtrate. The filtrate contains substantial amounts of calcium chloride and moderate amounts of calcium hypochlorite as well as calcium chlorate.

The '371 patent discloses a process wherein an effluent of an aqueous solution of calcium chloride, calcium chlorate and calcium hypochlorite is blended with a second mother liquor comprised of an aqueous solution of calcium chlorate and calcium chloride to form a blended solution which is fed to a first crystallizer to form a slurry of calcium chloride hydrate in a first mother liquor. The crystals of calcium chloride hydrate are separated from the first mother liquor which is fed to an evaporative crystallizer to form a crystalline calcium chlorate compound in a second mother liquor. The crystalline calcium chlorate compound is separated and recovered from the second mother liquor which is then re-fed to the first step of the process.

The '372 patent discloses a process for producing calcium chloride hexahydrate, calcium chloride tetrahydrate and calcium chloride dehydrate wherein an effluent comprised of an aqueous solution of calcium chloride, calcium hypochlorite and calcium chlorate is acidified with a chlorine containing compound selected from the group consisting of chlorine, hydrochloric acid and hydrogen chloride to produce an acidic aqueous solution of calcium chloride having reduced concentrations of calcium hypochlorite. Water is then evaporated from the acidic aqueous solution to from a concentrated acidic aqueous solution containing at least 45 percent by weight of calcium chloride, which is then fed to a crystallizer to form crystals of a calcium chloride hydrate. The crystals are then separated from the mother liquor and recovered.

U.S. Pat. No. 4,704,265, issued Nov. 3, 1987, to Krohn et al., relates to apparatus and methods for the production of calcium chloride by the reaction of hydrochloric acid and calcium carbonate. Krohn discloses apparatus and methods for producing an aqueous calcium chloride solution by locating a charge of calcium carbonate in a reaction vessel and contacting an aqueous solution containing hydrochloric acid with the calcium carbonate charge to produce carbon dioxide and the aqueous calcium chloride solution. The carbon dioxide produces a foam at the top of the aqueous calcium chloride solution which traps a portion of any fines contained within the solution. The foam and any fines entrained therein are then separated from the aqueous calcium chloride solution without the use of a filter. Thus, clarification of the aqueous calcium chloride solution by use of the Krohn apparatus and methods does not require the use of a filter.

U.S. Pat. No. 6,309,621, issued Oct. 30, 2001, to Abe et al., is directed to a process for producing high test hypochlorite and an aqueous calcium chloride solution from the same system resulting from chlorination of lime which contains calcium hypochlorite and calcium chloride. The Abe process comprises the steps of: a) dispersing calcium hydroxide in an aqueous solution substantially comprising calcium chloride to prepare milk of lime; b) chlorinating the milk of lime to crystallize calcium hypochlorite dehydrate in the presence of prismatic calcium hypochlorite dihydrate seed crystals to prepare a slurry of coarse calcium hypochlorite dihydrate crystals; c) separating the slurry into a wet cake of calcium hypochlorite dihydrate crystals and a mother liquor containing calcium hypochlorite and calcium chloride; d) drying the wet cake of calcium hypochlorite dihydrate crystals to provide high test hypochlorite; and e) adding hydrochloric acid to the mother liquor, or contacting the mother liquor with an oxide of at least one of Mn, Fe, Co, Ni, Cu, and Pd to decompose the calcium hypochlorite to obtain a calcium chloride aqueous solution.

U.S. Pat. No. 6,524,546, issued Feb. 5, 2003, to Rigby et al., discloses a process for producing calcium chloride and other metal halides from the carbonates, bicarbonates and oxides of these metals. The process is based on the concept that hydrogen halides, when used in a true or conventional fluidizing medium in shallow beds of the aforementioned solids at moderately elevated temperatures in a continuous counter current process result in the conversion of the metal carbonates, bicarbonates and oxides, into metal halides and carbon dioxide gas and/or water vapor. Rigby teaches the process is carried out in a series of true or conventional fluidized beds generally arranged in a vertical configuration so that the solids flow downward due to the fluidized process and the hydrogen halides flow counter currently in an upward direction producing metal halides at the bottom and pure carbon dioxide gas and/or water vapor at the top.

Canadian Patent 2,038,021 issued to Loots and Van Goftberg is directed to methods for producing calcium chloride comprising passing an anhydrous chlorine-containing gas through a bed, or a series of beds, of particles comprising at least one calcium-containing compound of the formula CaX₃₋ₙ wherein X is selected from CO₃, OH and O, and n is the valence of X, to convert the calcium-containing compound into solid calcium chloride. It is noted when X is OH, the bed is heated sufficiently, before or while the gas is passed therethrough, to convert the Ca(OH)₂ to CaO.

With respect to the '021 Loots and Van Groften process, the '546 Rigby patent notes that “[t]wo additional embodiments of the Loots and Van Gottberg invention both somewhat alike and described as a ‘fluidized bed’, teach a process in which either calcium carbonate, oxide, or hydroxide are contained in a reaction vessel or riser and reacted with hydrochloric acid and or chlorine from which the spent gas and the finished calcium chloride (entrained in the gas stream) is withdrawn.

Despite the advances in the art, conventional apparatus and methods for producing calcium chloride are unsatisfactory in that they suffer from limitations such as, for example, complex reaction steps, insufficient dispersion/mixing of reactants, insufficient crystallization, precipitation and/or filtration of desired product, impure product, they are energy and labor intensive, and/or produce gases damaging to the environment. Thus, there is still a need for improved apparatus and methods for producing calcium chloride.

### SUMMARY OF THE INVENTION

It is an object of the present invention to provide for apparatus and methods for producing calcium chloride.

It is an object of the present invention to provide for improved apparatus and methods for producing calcium chloride.

These and other objects of the present invention will become apparent to those skilled in the art upon review of this specification, drawings, claims and abstract.

According to one embodiment of the present invention, there is provided a method of producing calcium chloride. The method includes contacting water, calcium chloride, and at least one calcium compound selected from the group consisting of calcium hydroxide and calcium oxide to form a mixture. This mixture will include calcium hydroxide, either added to the mixture, or formed from the water slaking the calcium oxide. The method also includes contacting the mixture with hydrochloric acid to form a reaction mixture in which is formed calcium chloride. A further embodiment is directed to the composition comprising the mixture and the reaction mixture, and to products thereof.

According to another embodiment of the present invention, there is provided a method of producing calcium chloride. The method includes contacting a mixture comprising water, calcium chloride, and at least one calcium compound selected from the group consisting of calcium hydroxide and calcium oxide, with hydrochloric acid to form calcium chloride.

According to even another embodiment of the present invention, there is provided a method of producing calcium chloride. The method includes forming a mixture of water, calcium chloride, hydrochloric acid, and at least one calcium compound selected from the group consisting of calcium hydroxide and calcium oxide, to form calcium chloride. This mixture will include calcium hydroxide, either added to the mixture, or formed from the water slaking the calcium oxide. According to another embodiment there is provided a composition comprising the mixture, and to products thereof.

According to still another embodiment of the present invention, there is provided a method of producing calcium chloride. The method includes forming in a first reaction zone a first reaction mixture comprising water, hydrochloric acid, and at least one calcium compound selected from the group consisting of calcium hydroxide and calcium oxide, to form calcium chloride. The method also includes forming in a second reaction zone a second reaction mixture comprising calcium chloride from the first reaction zone, and water, hydrochloric acid, and at least one calcium compound selected from the group consisting of calcium hydroxide and calcium oxide, to form additional calcium chloride. The first and second reaction mixtures will include calcium hydroxide, either added to the mixture, or formed from the water slaking the calcium oxide.

In all of the above embodiments, the hydrochloric acid my be pretreated by contact with at least one oxidizing agent.

According to yet another embodiment of the present invention, there is provided a method of producing calcium chloride. The method includes contacting hydrochloric acid with an oxidizing agent to form a treated hydrochloric acid. The method also includes contacting calcium carbonate with the treated hydrochloric acid to form calcium chloride.

In all of the above embodiments, any suitable oxidizing agent may be utilized. Non-limiting examples of suitable oxidizing agents include H₂O₂, NaOCl, Ca(OCl)₂, Br₂, Cl₂, KMnO₃, and O₃.

According to even still another embodiment of the present invention, there is provided a method of producing iron (II) hydroxide, comprising contacting solid calcium oxide, hydrochloric acid, and an iron impurity with an aqueous solution of calcium chloride to form calcium hydroxide and iron (II) hydroxide, and there is provided a composition comprising the mixture.

The above embodiments also have applicability to the making of calcium halides in general, specifically, calcium bromide, calcium iodide, and calcium fluoride. In those cases, the acid utilized would be, respectively, HBr, HI, and HF, with the particular desired calcium halide used to slurry the calcium starting material.

These and other embodiments of the present invention will become apparent to those of skill in the art upon review of this specification, drawings, claims and abstract.

### BRIEF DESCRIPTION OF THE DRAWINGS

FIG. 1 is a flow chart of calcium chloride process 10, which is one embodiment of the process of the present invention, showing slurry tank 100, reactor 200, evaporator 300, storage tank 400 and filter 500.

FIG. 2 is a Table showing data and results for the examples.

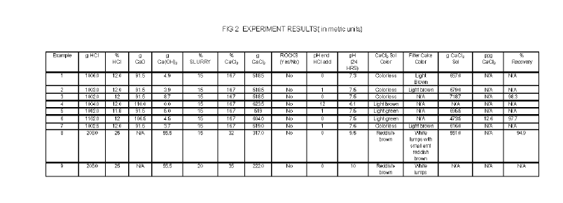

FIGS. 3-6 are Tables showing data for materials utilized in the examples.

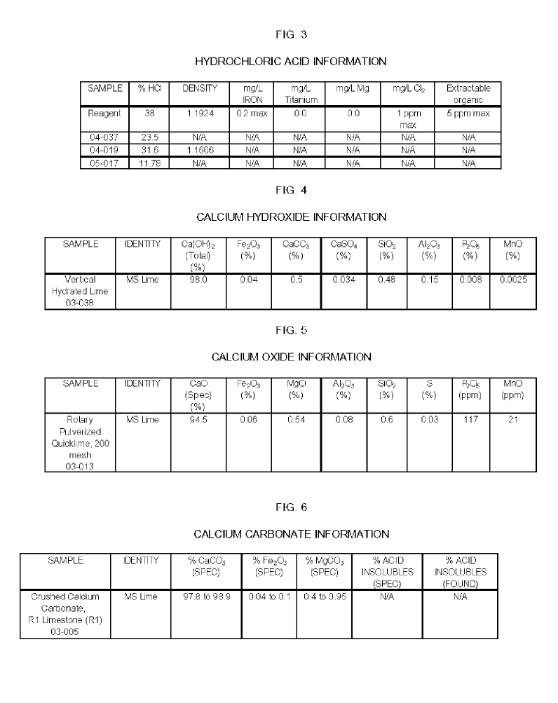

### DETAILED DESCRIPTION OF THE INVENTION

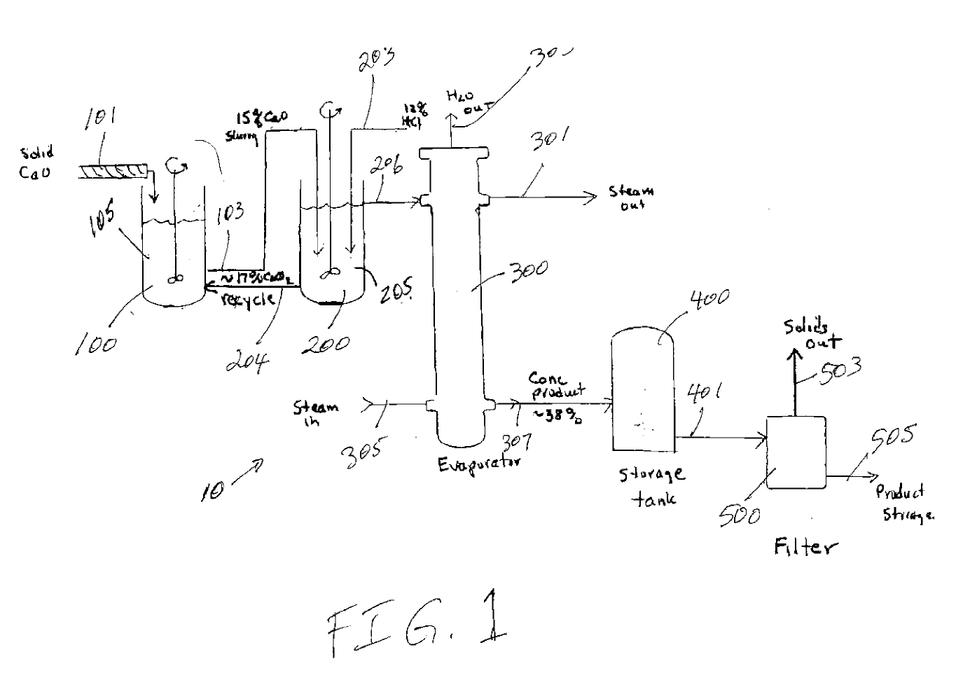

The present invention is best understood by reference to FIG. 1, a flow chart of calcium chloride process 10, which is one embodiment of the process of the present invention, showing slurry tank 100, reactor 200, evaporator 300, storage tank 400 and filter 500.

In general the process of the present invention includes reacting calcium oxide with water to form calcium hydroxide, and then reacting the calcium hydroxide with hydrochloric acid to form the desired calcium chloride and water. More specifically, in what is actually the rate limiting step, the calcium hydroxide is initially formed as a solid and must then be dissolved into an aqueous solution before reacting with hydrochloric acid.

Solid calcium oxide 101 is provided to slurry tank 100 along with recycle stream 204, which is an aqueous calcium chloride solution from reactor 200 to form mixture 105. The calcium chloride may generally be present up to its saturation point in water, preferably in the range of about 0.1 to about 40 weight percent, more preferably in the range of about 1 to about 25 weight percent, even more preferably in the range of about 12 to about 25 weight percent, and still more preferably in the range of about 8 to about 20 weight percent, all based on the weight of water and calcium chloride. The contacting of calcium oxide with the aqueous calcium chloride solution results in the hydration of the calcium oxide to form calcium hydroxide, an exothermic process.

The resulting mixture 105 comprises solid calcium compounds specifically, calcium hydroxide and/or calcium oxide, in an aqueous calcium chloride solution, generally in the range of about 0.1 to about 50 weight percent calcium compounds preferably in the range of about 3 to about 30 weight percent calcium compounds, and most preferably in the range of about 5 to about 20 weight percent calcium compounds, based on the total weight of the slurry. It should be understood, that mixture 105 preferably comprises a slurry, although less preferably mixture 105 may be thicker as to have the consistency of a paste.

While all of the calcium oxide is intended to be slaked into calcium hydroxide, the conversion may be limited by the amount of time in tank 100, and the amount of water present in mixture 105. Some slaking may continue downstream.

While any suitable form of the solid calcium oxide may be utilized in the present invention, it is preferred to utilize quicklime, that is, the product of the calcination of limestone. As limestone is a naturally occurring product, it should be understood that it will most likely contain impurities, most commonly, silica, iron, alumina and magnesia. As a result, it may be necessary to remove any by-products formed from these impurities, or to prevent, hinder, or deter formation of any by-products.

As the calcium oxide must initially react with water and the resulting hydrated lime must dissolve into the aqueous solution before reacting with hydrochloric acid, it is preferred that it be of suitable particle size to more readily facilitate those reactions. As a suitable example, calcium oxide is commercially available in a very suitable 200 mesh size, although, as a general rule, the smaller the particle size the better, provided that handling problems do not cause any undue problems.

Once slurry 105 is formed, process stream 103 feeds slurry 105 to reactor 200 where it is contacted with hydrochloric acid feed stream 203 to form reaction mixture 205. This reaction of calcium hydroxide and hydrochloric acid forms calcium chloride and is exothermic. Recycle stream 204 recycles aqueous calcium chloride solution back to slurry tank 100. In some instances discussed below, it may be desired to first treat hydrochloric acid feed stream 203 with an oxidizing agent, or to introduce the oxidizing agent into the process at some point.

Reactor 200 is operated to have an excess of calcium hydroxide relative to the stoichiometric amount of hydrochloric acid needed to form calcium chloride. In general, this excess of calcium hydroxide is utilized to maintain the pH of reaction mixture 205 in a range to minimize operating problems. If the pH gets too high, above about 12, iron is redissolved resulting in darker calcium chloride product. If the pH, gets too low, below about 8 or 9, magnesium hydroxide precipitates faster (for iron hydroxide it's below about 5.5). As a result, it is generally desired to maintain a pH of reactor mixture 205 in the range of about 9 to about 12, preferably in the range of about 10 to about 11.

The concentration of hydrochloric acid feed stream may be any suitable concentration that will produce the desired calcium chloride. Of course, at lower concentrations, more water is being introduced into the reaction system, which water at some point must be removed. The upper limit on hydrochloric acid concentration is its solubility in water. While highly concentrated hydrochloric acid may be utilized, one advantage of the present invention is that waste streams of hydrochloric acid from other processes may be utilized, with these waste streams containing in the range of 10 or 12 to about 42 weight percent hydrochloric acid, very commonly in the range of about 30 to about 38 weight percent hydrochloric acid.

Feed rates of slurry inlet stream 103 and hydrochloric acid feed stream 203 are controlled to maintain a desired excess amount of calcium hydroxide level in reactor 200 as described above.

In the practice of the present invention, reactor 200 is generally operated at a temperature that will allow the reaction mixture to be in the liquid state. As a non-limiting example, in the range of about 120F to about 200F at ambient pressure, although it should be understood that upper end operating temperatures will vary with operating pressure.

While the present invention has been illustrated as having separate slurry tank 100 and reactor 200, it should be understood that the present invention may be carried out using a single vessel, with the reactants all introduced to the vessel altogether or in any suitable order, or may be carried out using more vessels with the reactants introduced as desired. The present invention may also be carried out in a single vessel in the form of a flow tube reactor, with the reactants introduced to the reactor as desired.

Water as utilized in the invention may be added as a separate reactant, or may be added as the solvent along other reactants, for example, an aqueous solution of HCl, or aqueous solution of calcium chloride.

It should be understood that methods and apparatus for the recovery of calcium chloride from calcium chloride product steam 206 are well known, and any suitable method and apparatus may be utilized. Thus, the configuration shown in FIG. 1 of the evaporator 300, storage tank 400 and filter 500 should be understood as being merely a non-limiting example of a product recovery system and that the invention is not to be limited to this example.

Calcium chloride product stream 206 is then fed to evaporator 300 to concentrate the calcium chloride solution to the desired concentration. It should be understood that while only one evaporator 300 is shown, any suitable number of evaporators operating in series or parallel may be utilized. In the embodiment as shown, counter current flow of steam, entering as inlet steam line 305 and exiting as outlet steam line 301, provides the necessary heat for evaporation of water 303. Under certain operating conditions utilizing concentrated hydrochloric acid, higher flow rates of reactants into reactor 200 and/or operating the reactor 200 under vacuum, the heat of reaction will drive the reaction to the point of boiling off a good amount of the aqueous solution and resulting in a more concentrated product. Under these conditions, it may be possible to eliminate or at the very least to reduce the evaporation load. It may also be desired to utilize heat from the exothermic slaking process in tank 100.

In the embodiment as shown, concentrated calcium chloride stream 307 is then fed to storage tank, 400, and then thru steam 401 to filter 500, where solids 503 are removed, and final calcium chloride product steam 505 is recovered.

Applicants have found that under certain circumstances, namely, the use of higher concentration hydrochloric acid with concentration above 20%, for example, a reagent grade 38% acid, and namely an impurity of iron in the calcium oxide, will result in the production of iron(II)hydroxide resulting in a clear, green solution of calcium chloride. Applicants have also found that pretreatment of the hydrochloric acid with an oxidizing agent such as the preferred hydrogen peroxide will prevent the formation of the green solution of calcium chloride. Other examples of suitable oxidizing agents include NaOCl, Ca(OCl)₂, Br₂, Cl₂, KMnO₃, and O₃. Ca(OCl)₂ Is also preferred.

It is believed that this pretreatment of hydrochloric acid may also have applicability in the traditional processes for making calcium chloride, specifically in which hydrochloric acid reacts with calcium carbonate to form calcium chloride. Thus, according to another embodiment of the present invention, there is provided a method of making calcium chloride by first pretreating hydrochloric acid with an oxidizing agent, and then reacting the pretreated hydrochloric acid with calcium carbonate.

The process of the present invention may be carried out as a continuous, batch or semi-batch process.

While the present invention has been discussed mainly by reference to the making of calcium chloride, it also finds utility in the making of calcium halides in general, specifically, calcium bromide, calcium iodide, and calcium fluoride. In those cases, the acid utilized would be HBr, HI, and HF, with the particular desired calcium halide used to slurry the calcium oxide and/or hydroxide. Thus, the present invention is also intended to be directed to the making of calcium halides in general.

### EXAMPLES

The following examples are provided merely to illustrate a few embodiments of the present invention, and the present invention and the claims of the invention are not to be limited by these examples.

### Example 1

Step One: A 15.0% slurry of calcium oxide in 16.7% calcium chloride solution was prepared. The mixture was vigorously stirred. The amount of calcium oxide added (91.5 g) was equal to the amount required to react with the hydrochloric acid added.

Step Two: The reagent hydrochloric acid concentration was adjusted to 12% with deionized water. Just before the hydrochloric acid was added to the calcium oxide slurry, two mL of 30% hydrogen peroxide was added to the 12% hydrochloric acid.

Step Three: The hydrochloric acid was added from a dropping funnel to the vigorously stirred hydrated calcium oxide slurry. The pH at the end of the hydrochloric acid addition was measured with pH paper, and was about 0. The pH of the solution was adjusted to approximately 10 by the addition of 32.5 g of a 15% CaO slurry in 16.7% CaCl₂.

Step Four: With stirring, the solution was concentrated by the removal of about 965 g of water. The concentrated solution was aged for 24 hours.

Step Five: The solids were removed by filtration from the aged concentrated solution. The filter cake was white. The pH of the filtrate was 7.3 and was not adjusted.

Step Six: The calcium chloride solution was colorless.

### Example 2

Step One: A 15.0% slurry of calcium oxide in 16.7% calcium chloride solution was prepared. The mixture was vigorously stirred. The amount of calcium oxide added (91.5 g) was equal to the amount required to react with the hydrochloric acid added.

Step Two: The reagent hydrochloric acid concentration was adjusted to 12% with deionized water. Just before the hydrochloric acid was added to the calcium oxide slurry, two mL of 30% hydrogen peroxide was added to the 12% hydrochloric acid.

Step Three: The hydrochloric acid was added from a dropping funnel to the vigorously stirred hydrated calcium oxide slurry. The pH at the end of the hydrochloric acid addition was not measured, but was low, estimated to be about 1. The pH of the solution was adjusted to approximately 10 by the addition of 26.0 g of a 15% CaO slurry in 16.7% CaCl₂.

Step Four: With stirring, the solution was concentrated by the removal of about 940 g of water. The concentrated solution was aged for 24 hours.

Step Five: The solids were removed by filtration from the aged concentrated solution. The filter cake was a light brown. The pH of the filtrate was 7.2, requiring no adjustment.

Step Six: The calcium chloride solution was colorless. The solution was 36.5% calcium chloride.

### Example 3

Step One: A 15.0% slurry of calcium oxide in 16.7% calcium chloride solution was prepared. The mixture was vigorously stirred. The amount of calcium oxide added (100.0 g) was equal to the amount required to react with the hydrochloric acid added.

Step Two: The (04-037) hydrochloric acid (23.5%) was used without dilution.

Step Three: The hydrochloric acid was added from a dropping funnel to the vigorously stirred hydrated calcium oxide slurry. The pH at the end of the hydrochloric acid addition was not measured, but was low, estimated to be about 0. The solution was a yellow color, with yellow solids. The pH of the solution was adjusted to approximately 12 by the addition of 39.0 g of a 15% CaO slurry in 16.7% CaCl₂.

Step Four: With stirring, the solution was concentrated by the removal of about 742 g of water.

Step Five: The solids were filtered from the solution. The pH of the filtrate (start 12.0) was adjusted to pH 7.5 with 6N HCl.

Step Six: The calcium chloride solution was a light yellow.

Step Seven After standing overnight, no solids precipitated from the solution.

### Example 4

Step One: A 15.0% slurry of calcium oxide in 16.7% calcium chloride solution was prepared. The mixture was vigorously stirred. The amount of calcium oxide added (110.0 g) was 1.2 times the amount required to react with the hydrochloric acid added.

Step Two: The reagent hydrochloric acid concentration was adjusted to 12% with deionized water. The hydrochloric acid solution was placed in a 2 L beaker.

Step Three: The calcium oxide slurry was pumped into the vigorously stirred hydrochloric acid solution. The pH at the end of the CaO slurry addition was measured with pH paper, and was about 12.

Step Four: With stirring, the solution was concentrated by the removal of about 1000 g of water. The concentrated solution was aged for 24 hours.

Step Five: The solids were removed by filtration from the aged concentrated solution. The pH of the filtrate (initial pH=9.6) was adjusted to 6.1 with 6N HCl.

Step Six: The concentrated calcium chloride solution was light brown in color.

### Example 5

Step One: A 15.0% slurry of calcium oxide in 16.7% calcium chloride solution was prepared. The mixture was vigorously stirred. The amount of calcium oxide added (91.5 g) was equal to the amount required to react with the hydrochloric acid added.

Step Two: The (05-017) hydrochloric acid concentration was used without any concentration adjustment.

Step Three: The hydrochloric acid was added from a dropping funnel to the vigorously stirred hydrated calcium oxide slurry. The pH at the end of the hydrochloric acid addition was not measured, but was low, estimated to be about 0. The pH of the solution was adjusted to approximately 12 by the addition of 33.0 g of a 15% CaO slurry in 16.7% CaCl₂. The solids were filtered from the solution.

Step Four: The pH of the filtrate (start 10.8) was adjusted to pH 7.5 with 6N HCl.

Step Five: With stirring, the solution was concentrated by the removal of about 880 g of water.

Step Six: The calcium chloride solution was a light green. The pH of the concentrated calcium chloride was 6.6.

Step Seven: After standing overnight, no solids precipitated from the solution.

### Example 6

Step One: A 15.0% slurry of calcium oxide in 16.7% calcium chloride solution was prepared. The mixture was vigorously stirred. The amount of calcium oxide added (106.5 g) was equal to 1.16 times the amount required to react with the hydrochloric acid added.

Step Two: The reagent hydrochloric acid concentration was adjusted to 12% with deionized water.

Step Three: The hydrochloric acid was added from a dropping funnel to the vigorously stirred hydrated calcium oxide slurry. The pH at the end of the hydrochloric acid addition was not measured, but was low, estimated to be about 1. At this point, two mL of 30% hydrogen peroxide was added to the reaction mixture. The pH of the solution was adjusted to approximately 10.5 with reagent grade calcium hydroxide (4.5 g). The solids were filtered from the solution.

Step Four: With stirring, the solution was concentrated by the removal of about 1300 g of water. After cooling, a small amount of solids separated from the solution. The solids were filtered from the solution.

Step Five: The pH of the filtrate (start 9.1) was adjusted to pH 7.5 with 6N HCl.

Step Six: The calcium chloride solution was a light green with an hydrometer density of 1.514 at 73° F.

Step Seven: After standing overnight, no solids precipitated from the calcium chloride solution.

### Example 7

Step One: A 15.0% slurry of calcium oxide in 16.7% calcium chloride solution was prepared. The mixture was vigorously stirred. The amount of calcium oxide added (91.5 g) was equal to the amount required to react with the hydrochloric acid added.

Step Two: The reagent hydrochloric acid concentration was adjusted to 12% with deionized water. Just before the hydrochloric acid was added to the calcium oxide slurry, 24 g of a 6.1% sodium hypochlorite solution was added to the 12% hydrochloric acid.

Step Three: The hydrochloric acid was added from a dropping funnel to the vigorously stirred hydrated calcium oxide slurry. The pH at the end of the hydrochloric acid addition was not measured, but was low, estimated to be about 1. The pH of the solution was adjusted to approximately 11 by the addition of 24.5 g of a 15% CaO slurry in 16.7% CaCl₂. The solids were filtered from the solution.

Step Four: The pH of the filtrate (start 9.8) was adjusted to pH 7.6.

Step Five: With stirring, the solution was concentrated by the removal of about 970 g of water.

Step Six: The calcium chloride solution was colorless.

Step Seven: After standing overnight, a small amount of solids precipitated from the solution. The calcium chloride solution turned a light brown color over several days.

### Example 8

Step One: A 15% slurry of calcium hydroxide in 32% calcium chloride solution was prepared. The mixture was vigorously stirred. The amount of calcium hydroxide added (55.5 g) was 1.05 times the amount required to react with the hydrochloric acid added.

Step Two: The reagent hydrochloric acid concentration was adjusted to 25% with deionized water.

Step Three: The hydrochloric acid was added from a dropping funnel to the vigorously stirred calcium hydroxide slurry. The pH at the end of the hydrochloric acid addition was about 0. The solution was allowed to stir for 2½ hours. The pH increased to about 12. Stirring was stopped, and the solution was aged for 24 hours.

Step Four: The solids were filtered from the solution.

Step Five: The pH of the filtrate (9.5) was adjusted to about 7.5 with 6 N and 1 N HCl

Step Six: The calcium chloride solution has a rust color (reddish-brown) at pH 7.5.

### Example 9

Step One: A 20% slurry of calcium hydroxide in 35% calcium chloride solution was prepared. The mixture was vigorously stirred. The amount of calcium hydroxide added was 1.05 times the amount required to react with the hydrochloric acid added.

Step Two: The reagent hydrochloric acid concentration was adjusted to 25% with deionized water.

Step Three: The hydrochloric acid was added from a dropping funnel to the vigorously stirred calcium hydroxide slurry. The pH at the end of the hydrochloric acid addition was approximately 0. The solution was yellow at this pH.

Step Four: The solution was allowed to stir for several hours. The pH increased to approximately 7. The pH of the solution was raised to about 10.3 by the addition calcium hydroxide. The pH was measured by pH paper. The beaker was covered so that the amount of iron oxide flaking from the rusting equipment into the calcium chloride solution is minimized. The beaker was uncovered during the HCl addition.

Step Five: The solids were filtered from the solution.

Step Six: The pH of the filtrate was adjusted to about 6.5 with 6 N and 1 N HCl

Step Seven: The calcium chloride solution has a rust (reddish-brown) color. Some iron is present, but less than in previous preparations.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

All material cited in the specification and drawings including domestic and foreign patents and patent applications, books, articles, and publications, are herein incorporated by reference for all that they disclose and suggest.

What is claimed is:

1. A method of producing a calcium chloride, comprising the steps of:
Contacting water, calcium chloride, and at least one calcium compound selected from the group consisting of calcium hydroxide and calcium oxide to form a mixture; and
Contacting the mixture with hydrochloric acid to form the calcium chloride.

2. The method of claim 1, wherein the hydrochloric acid has been contacted with at least one oxidizing agent.

3. The method of claim 2, wherein the oxidizing agent is selected from the group consisting of H₂O₂, NaOCl, Ca(OCl)₂, Br₂, Cl₂, KMnO₃, and O₃.

4. The method of claim 3, wherein the oxidizing agent comprises H₂O₂.

5. The method of claim 1, wherein the calcium compound comprises calcium oxide.

6. The method of claim 5, wherein the calcium oxide comprises quicklime.

7. The method of claim 1, wherein the calcium compound comprises calcium hydroxide.

8. The method of claim 1, wherein there is a stoichiometric excess of calcium hydroxide with respect to the hydrochloric acid.

9. A method of producing calcium chloride, comprising the steps of:
Contacting a mixture comprising water, calcium chloride, and at least one calcium compound selected from the group consisting of calcium hydroxide and calcium oxide, with hydrochloric acid to form calcium chloride.

10. The method of claim 9, wherein the hydrochloric acid has been contacted with at least one oxidizing agent.

11. The method of claim 10, wherein the oxidizing agent is selected from the group consisting of H₂O₂, NaOCl, Ca(OCl)₂, Br₂, Cl₂, KMnO₃, and O₃.

12. The method of claim 11, wherein the oxidizing agent comprises H₂O₂.

13. The method of claim 9, wherein the calcium compound comprises calcium oxide.

14. The method of claim 9, wherein the calcium oxide comprises quicklime.

15. The method of claim 9, wherein the calcium compound comprises calcium hydroxide.

16. The method of claim 9, wherein there is a stoichiometric excess of calcium hydroxide with respect to the hydrochloric acid.

17. A method of producing calcium chloride, comprising the steps of:
Contacting water, calcium chloride, hydrochloric acid, and at least one calcium compound selected from the group consisting of calcium hydroxide and calcium oxide, to form calcium chloride.

18. The method of claim 17, wherein the hydrochloric acid has been contacted with an oxidizing agent.

19. The method of claim 18, wherein the oxidizing agent is selected from the group consisting of H₂O₂, NaOCl, Ca(OCl)₂, Br₂, Cl₂, KMnO₃, and O₃.

20. The method of claim 19, wherein the oxidizing agent comprises H₂O₂.

21. The method of claim 17, wherein the calcium compound is calcium oxide.

22. The method of claim 21, wherein the calcium oxide comprises quicklime.

23. The method of claim 17, wherein the calcium compound comprises calcium hydroxide.

24. The method of claim 17, wherein there is a stoichiometric excess of calcium hydroxide with respect to the hydrochloric acid.

25. A method of producing calcium chloride comprising the steps of:
Forming in a first reaction zone a first reaction mixture comprising water, hydrochloric acid, and at least one calcium compound selected from the group consisting of calcium hydroxide and calcium oxide, to form calcium chloride;
Forming in a second reaction zone a second reaction mixture comprising calcium chloride from the first reaction zone, and water, hydrochloric acid, and at least one calcium compound selected from the group consisting of calcium hydroxide and calcium oxide, to form additional calcium chloride.

26. The method of claim 25, wherein the hydrochloric acid has been contacted with an oxidizing agent.

27. The method of claim 26, wherein the oxidizing agent is selected from the group consisting of H₂O₂, NaOCl, Ca(OCl)₂, Br₂, Cl₂, KMnO₃, and O₃.

28. The method of claim 27, wherein the oxidizing agent comprises H₂O₂.

29. The method of claim 25, wherein the calcium compound is calcium oxide.

30. The method of claim 29, wherein the calcium oxide comprises quicklime.

31. The method of claim 25, wherein the calcium compound comprises calcium hydroxide.

32. The method of claim 25, wherein there is a stoichiometric excess of calcium hydroxide with respect to the hydrochloric acid.

33. A method of producing iron (II) hydroxide, comprising the step of:
Contacting solid calcium oxide, hydrochloric acid, and an iron impurity with an aqueous solution of calcium chloride to form calcium chloride and iron (II) hydroxide.

34. A method of producing calcium chloride comprising the steps of
Contacting hydrochloric acid with an oxidizing agent to form a treated hydrochloric acid; and
Contacting calcium carbonate with the treated hydrochloric acid to form calcium chloride.

35. The method of claim 34, wherein the oxidizing agent is selected from the group consisting of H₂O₂, NaOCl, Ca(OCl)₂, Br₂, Cl₂, KMnO₃, and O₃.

36. The method of claim 35, wherein the oxidizing agent comprises H₂O₂.
